(19) United States
(12) Patent Application Publication
(10) Pub. No.: US 2004/0264419 A1
(43) Pub. Date: Dec. 30, 2004

(54) Reception apparatus and method using a post-descrambling scheme in a mobile communication system for code division multiple access

(76) Inventors: Noh-Sun Kim, Suwon-shi (KR); Hun-Kee Kim, Seoul (KR); Young-Seok Lim, Seoul (KR); Gin-Kyu Choi, Seoul (KR); Jung-Wook Yoon, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/830,421

(22) Filed: Apr. 23, 2004

(30) Foreign Application Priority Data
Apr. 23, 2003 (KR) 2003-25795

(51) Int. Cl. H04B 7/216

(52) U.S. Cl. 370/335; 370/342; 370/519

(57) ABSTRACT

Disclosed is a reception apparatus employing a post-descrambling scheme in a mobile communication system for code division multiple access and provides methods which are used for channel-compensating received multi-path signals, sorting the channel-compensation signals according to positions in time in consideration of multi-path latency, combining the sorted signals, and descrambling each of the combined signals by means of one of preset scrambling codes in a reception apparatus of Code Division Multiple Access (CDMA) mobile communication system.

### PRIORITY

This application claims priority to an application entitled “Reception Apparatus and Method employing Post-descrambling Scheme in Mobile Communication System for Code Division Multiple Access” filed in the Korean Intellectual Property Office on Apr. 23, 2003, and assigned Serial No. 2003-25795, the contents of which are incorporated herein by reference.

### BACKGROUND OF THE INVENTION

1. Field of the Invention

The present invention relates to a mobile communication system for code division multiple access, and more particularly to a apparatus and method employing a post-descrambler.

2. Description of the Related Art

Presently, mobile communication systems for Code Division Multiple Access (CDMA), such as the IS-2000, have simply provided voice services, low speed packet data services and circuit data services. However, CDMA mobile communication systems have been developed to provide packet data services at a high speed and large capacity, including voice services, low speed packet data services and circuit data services. Mobile communication systems for supporting high speed packet data services, such as the IS-2000 and First Evolution Data and Voice (1x-EVDV), have been actively studied. As a result, the implementation of a mobile station, which can process high speed packet data, is indispensable to mobile communication systems for supporting high speed packet data services with voice services.

Since a plurality of users or stations separate and use all usable Walsh codes, the CDMA mobile communication systems based on general voice services transfer data by allocating at least one of all available Walsh codes to one data channel. Also, the CDMA mobile communication systems have phase distortion in received signals resulting from fading, which occurs when a wireless channel transfers high speed data. The fading forces the amplitude of the received signals to be attenuated at a rate from several dBs to tens of dBs. For this reason, when data is modulated, the phase of the received signal distorted by the fading must be compensated, or otherwise erroneous data is transferred from a transmission apparatus, so that quality of services is degraded in the CDMA mobile communication. Therefore, the problem of fading must be overcome in order to transfer high speed data in CDMA mobile communication systems.

Many kinds of diversity modes are used to cope with the fading. Generally, CDMA mobile communication use a rake reception apparatus to accept diversity by applying a delay spread of channel signals. The rake reception apparatus includes a plurality of fingers. Each of the fingers demodulates the received signal by using an assigned path signal. Symbols modulated from each of the fingers are combined in a multi-path symbol combiner.

However, the mobile communication systems for supporting the high speed packet data services, such as High Speed Downlink Packet Access (HSDPA) mobile communication systems, 1x-EVDV mobile communication systems with synchronous mode, use a dedicated packet data control channel to enhance transmission efficiency of packet data channels, and have a structure for controlling packet data channels with the dedicated packet data control channel. The CDMA-based mobile communication systems variably assign users all available Walsh codes in order to support the high speed packet data service. This assignment has an advantage in that resources can be efficiently used. For example, the variable assignment of Walsh codes has merit in terms of using network resources.

FIG. 1 is a block diagram illustrating an example of a structure of a transmission apparatus of general HSDPA mobile communication systems.

Referring to FIG. 1, the transmission apparatus includes a channel encoder 100, a rate matcher 102, a interleaver 104, a modulator 106, an Adaptive Modulation and Coding Scheme (AMCS) controller 108, a de-multiplexer (DEMUX) 110, a spreader 112 and 113, an adder 114, and a scrambler 116. First, N Transport Blocks are input to the channel encoder 100, the channel encoder 100 generates coded bits by encoding the transport blocks with preset channel encoding mode and outputs the coded bits to the rate matcher 102. The rate matcher 102 performs rate-matching for the coded bits, which are output from the channel encoder 100, in order to make them suitable for transmission on the physical channel and outputs the rate-matched coded bits to the interleaver 104. Herein, the rate matcher 102 is concordant with bits transmitted on physical channels with performing a puncturing or a repeated rate-matching, when the bits are different from the coded bits output from the channel encoder 100 or produced by multiplexing a transmission channel.

The interleaver 104 receives the signal from the rate matcher 102 and performs interleaving to protect against burst error, and then outputs the signal to the modulator 106. The modulator 106 receives the coded bits from the interleaver 104, converts the coded bits into modulator symbols by modulating with a preset modulator method and outputs the modulator symbols to the DEMUX 110. Herein, the modulator method includes Phase Shift Keying (M-PSK), Quadrature Amplitude Modulation (M-QAM), etc. Also, the AMCS controller 108 controls a channel encoding mode of the channel encoder 100 and a modulating mode of the modulator 106, wherein both modes are intended to be suitable for present states of wireless channels. That is, the AMCS controller 108 controls the channel encoding method and the modulating method to be suitably set according to the states of wireless channels to enhance data transmission efficiency. The DEMUX 110 receives signals output from the modulator 110, de-multiplexes the signals to be corresponded to a channel format and then outputs the multiplexed signals to the spreader 112 and 113. The transmission apparatus has only two spreaders 112 and 113 in FIG. 1. It is preferred that the number of the spreaders be equal to that of the DEMUXs 110. The spreaders 112 and 113 spread the input signals by corresponding Walsh codes. The spreaders 112 and 113 multiply a first Walsh code by a signal from the DEMUX 110 and output the multiplied signal to the adder 114. In this method, an M^{th} spreader multiplies the M^{th} Walsh code to a signal from the M^{th} DEMUX 110 and output the multiplied signal to the adder 114. Consequently, the signals from each of the spreader 112 and 113 are different channel signals. The adder 114 receives the signals from each of the spreaders, sums the signals, and outputs the summed signals to the scrambler 116. The scrambler 116 scrambles by multiplying the signal from the adder by a scrambling code c and outputs. Herein, the scrambling code c is used to classify base stations.

The HSDPA mobile communication systems make a plurality of user equipments share whole downlink transmission resources. Herein, the downlink transmission resources include transmit power, an orthogonal code as an orthogonal variable spreading factor (OVSF) code, etc. The HSDPA mobile communication systems can employ the OVSF code having a spreading factor (SF) of 16. Because the HSDPA mobile communication systems makes use of the OVSF code having an SF of 16, they can have a maximum 15 OVSF codes. The 1x-EVDV mobile communication systems can employ the OVSF code having a spreading factor (SF) of 16, thus, they can have a maximum 28 OVSF codes.

Meanwhile, the HSDPA mobile communication system can multiplex OVSF codes for a plurality of user terminals at a specific time. Next, the OVSF code multiplexing will be described below with reference to FIG. 2.

FIG. 2 is a diagram illustrating one example of allocating OVSF codes in a general HSDPA mobile communication system. In particular, the OVSF codes having an SF of 16 will be described as one example. With reference to FIG. 2, each of the OVSF codes is illustrated as w(i, j) according to a code tree, where i represents a spreading coefficient, and j represents a position from the farthest left side of OVSF code tree. For instance, w(16, 0) represents that OVSF code has 16 for the SF and the OVSF code is located at the first from the farthest left side. Referring to FIG. 2, as SF is 16, a 5^{th} to 16^{th} OVSF codes from the most left of OVSF code tree, from w(16,5) to w(16, 15), 12 OVSF codes, are assigned to the high speed downlink packet access communication systems. The 12 OVSF codes can be multiplexed for a plurality of user elements, for example, as in Table 1 given below.

TABLE 1

| | Time | | |
|---|---|---|---|
| User | t0 | t1 | t2 |
| A | C(16,6)˜C(16,7) | C(16,6)˜C(16,8) | C(16,6)˜C(16,7) |
| B | C(16,8)˜C(16,10) | C(16,9)˜C(16,10) | C(16,11)˜C(16,14) |
| C | C(16,11)˜C(16,15) | C(16,11)˜C(16,15) | C(16,15) |

In Table 1, each of A, B and C is an arbitrary user's terminal using the HSDPA mobile communication systems. Referring to Table 1, the user's terminal, A, B and C, multiplexes OVSF codes assigned from the HSDPA mobile communication systems at arbitrary points of time, t0, t1 and t2. A base station determines the number of OVSF codes and their positions on an OVSF code tree. Namely, the base station determines the number of OVSF codes and their position on the OVSF code tree, assigned to each user's terminal and considers the channel set assigned to the user's terminal and the base station.

Next, below is described the operation of the spreader 112 and 113 in FIG. 1.

As described in FIG. 1, the spreaders 112 and 113 spread channel signals by means of respective Walsh codes. Accordingly, the Walsh code is called a channelization code. In this case, it is assumed that the OVSF code is used as the channelization code, the orthogonality of which will be explained with reference to FIG. 3.

FIG. 3 is a diagram illustrating an example of the structure for a general OVSF code tree.

With reference to FIG. 3, the OVSF code tree is constructed based on the value of the SF. All of the OVSF codes, which have the same value of the SF or are stems from other mother codes, are orthogonal to one another. Therefore, when the OVSF codes are used for channelization code, signals through different physical channels do not interfere with one another because physical channels are orthogonal to one another. Consequently, the reception performance is improved.

Hereinafter, the operation of the scrambler 116 in FIG. 1 will be explained.

As described in FIG. 1, the scrambler 116 scrambles input signals. The structure of the scrambler 116 is shown in FIGS. 4 and 5. The scrambler 116 multiplies a signal from the adder 114 to a scrambling code c. The structure generating the scrambling code c is not shown in FIG. 1, but is the same as that shown in FIG. 4.

FIG. 4 is a diagram illustrating an example of an internal structure of a transmitter scrambling code generator.

Before the description of FIG. 4, it will be described how a complex downlink scrambling code is generated using a gold sequence that is produced by the operation of the position-wise modulo-3 sum for a 38400 chip of two binary m-sequence. An imaginary part of the binary m-sequence, used to generate the complex downlink long scrambling code, is produced by the 131,072 chip cyclic shifted version of a real part of the binary m-sequence. The procedure generating the complex downlink long scrambling code using two binary m-sequence, an x-sequence and y-sequence , is explained below.

First, The x-sequence and y-sequence are produced by the 18^{th} order generator polynomial.

x-sequence: x¹⁸+x⁷+1 (1)

y-sequence: x¹⁰+x¹⁷+x⁷+x⁵+1 (2)

As mentioned above, the structure of generating the complex downlink long scrambling code is illustrated in FIG. 4, wherein the code includes two binary m-sequences, an x-sequence and a y-sequence.

With reference to FIG. 4, a general transmission apparatus involves two mask registers, which are used for the I- and Q-channel of the x-sequence, in order to support an environment using a plurality of physical channels by mean of different scrambling codes. Two scrambling codes are generated from the two mask registers, respectively. Consequently, each of scrambling codes for the I- and Q-channel are generated by two mask registers, respectively.

Next, the internal structure of the scrambler 116 of FIG. 1 will be described with reference to FIG. 5.

FIG. 5 is a diagram illustrating an example of the internal structure of the scrambler 116 of FIG. 1.

As described in FIG. 4, fist of all, the scrambler 116 receives two scrambler codes output from the scrambling code generator. Of the two scrambler codes, one is scrambling_code_I for the I-channel signal, and the other is scrambling_code_Q for the Q-channel signal. The I- and the Q-channel signal are not separated in FIG. 1, but the scrambler 116 actually receives the I- and Q-channel separately. Thus, the I- and the Q-channel signal output from the adder 114 are called input signal and input signal_Q, respectively. The scrambler 116 respectively scrambles the input signal_I and the input signal_Q, output from the adder 114, with two scrambling codes scrambling_code_I and scrambling_code_Q, generated from the scrambling generator. The scrambled input signal_I and input signal_Q are called output signal_I and output signal_Q, respectively.

Secondly, the generation procedure generation of output signal_I and output signal_Q is described in detail below. First, the scrambler 116 includes a plurality of XOR (exclusive OR) gates 511, 513, 515, 517 and 519 and a plurality of adders 521 and 523. The input signal_I and the input signal_Q, output from the adder 114, are input to the XOR gates 511 and 519 and the XOR gates 513 and 517, respectively. The XOR gate 511 operates the input signal_{—}1 xor scrambling_code_I, which is a scrambling code generated by the scrambling code generator, and outputs to the adder 521. The XOR gate 513 operates the input signal_Q xor scrambling_code_Q, which is a scrambling code generated by the scrambling code generator, and then outputs to the adder 523. The XOR gate 519 operates the input signal_I xor a signal from the XOR gate 515 and outputs to the adder 523. Herein, the signal output from the XOR gate 515 is a result which operates scrambling_code_Q xor −1. The XOR gate 517 xors the input signal_Q and a signal from the XOR gate 515 and outputs to the adder 521. The adder 521 adds a signal output from the XOR gate 511 to a signal output from the XOR gate 517 and outputs output signal_I . Also, the adder 523 adds a signal output from the XOR gate 513 to a signal output from the XOR gate 519 and outputs output signal_Q. Consequently, the output signal_I and the output signal_Q are transformed to Radio Frequency (RF) band signals, and then transmitted by a plurality of antennas.

Hereinafter, a channelization procedure using OVSF code is described with reference to FIG. 6.

FIG. 6 is a diagram illustrating an example of the channelization procedure for using OVSF code.

As depicted on FIG. 6, it is assumed that two antennas, a first antenna (antenna 1) and a second antenna (antenna 2), are used for the channelization procedure, and that L channels are transmitted on the channelization procedure. As a result, FIG. 6 shows the internal structure of the spreaders 112 and 113 shown in FIG. 1. Although FIG. 1 shows neither separated I- and Q-channel signals nor the number of antennas, it is assumed that L channel data are spread by each of the two antennas as shown in FIG. 6.

A first antenna input data_I and a first antenna input data_Q, which are transmitted by the first antenna, are input to a first antenna spreader 610. Herein, the first antenna spreader 610 channelizes for a first channel of L channels. The first antenna input data_I and input data_Q, which are input to the first antenna spreader 610, are output to multipliers 611 and 613, respectively. The multiplier 611 multiplies the first input data_I by a first channel code, OVSF_CODE_{—}1, assigned to channelization code of the first channel. The multiplier 613 multiplies the first input data_Q by OVSF_CODE_{—}1 and outputs. Other channels of L channels, except the first channel are channelized by the method applied for the first channel. Each of the L channels is channelized by different channel code. Consequently, each channel has orthogonality.

Meanwhile, a second antenna input data I and input data_Q, which are transmitted by the second antenna, are input to a second spreader 620. Herein, the second antenna spreader 620 channelizes for a first channel of L channels. The second input data_I and input data_Q, input to the second antenna spreader 620, are output to multiplier 621 and multiplier 623 , respectively. The multiplier 621 multiplies the second input data_I by OVSF_CODE_{—}1 and outputs. The multiplier 623 multiply the second input data Q by OVSF_CODE_{—}1 and outputs. Each of the L channels is channelized by different channel code.

Hereinafter, a reception apparatus structure of a general HSPDPA mobile communication system is described with reference to FIG. 7.

FIG. 7 is a block diagram illustrating an example of the reception apparatus structure of a general HSDPA mobile communication system.

With reference to FIG. 7, the reception apparatus includes a finger unit 710, a combining unit 720, a Tx antenna diversity decoder 730, a demodulator 740 and a decoder 750. The finger unit 710 includes a plurality of fingers(e.g. M fingers), a first finger to an M^{th} finger. The combining unit 720 includes a plurality of combiners (e.g. L combiners), a first combiner to an L^{th} combiner.

First, signals are received by an antenna. The received signals are multi-path signals, which have been subjected to fading. Signals on the multi-path are connected to each targeted fingers. Thus, the reception apparatus has to comprise many fingers in order to determine gains of signals according to multi-path. As the internal structure of the finger unit will be described below, that description is omitted in this paragraph. The first finger 711 to the M^{th} finger process the signals input to each finger and output to the combining unit 720.

The combining unit 720 combines signals output from the finger unit 710 and then outputs to the transmission apparatus antenna diversity decoder 730. The description of the internal structure of the combining unit 720 to be depicted below are omitted in this paragraph. The transmission apparatus antenna diversity decoder 730 decodes signals output from the combining unit 720 by means of a transmission apparatus antenna diversity encoding method for transmission apparatus corresponding to the reception apparatus. The demodulator 740 demodulates signals output from the transmission apparatus antenna diversity decoder 730 by means of a demodulating method corresponding to a modulating method for the transmission apparatus and then outputs encoded signals to the decoder 750. Herein, signals just before the demodulator 740 are coded by the symbols and is transformed into bits coded by the demodulator 740. The decoder 750 decodes coded bits output from the demodulator 740 into information bits by means of a decoding method corresponding to an encoding method for the transmission apparatus and outputs the information bits.

Hereinafter, a internal structure of a finger unit and of the combiner unit is described with reference to FIG. 8.

FIG. 8 is a block diagram illustrating an example of the internal structure of a finger unit and of the combiner unit shown in FIG. 7.

With reference to FIG. 8, the finger unit 710, as explained in FIG. 7, includes a plurality of fingers (e.g., M fingers). The combining unit 720 includes L by 2 deskewers 841, 851, 861, 871, 881 and 891 and L by 2 combiners 843, 853, 863, 873, 883 and 893. First, the internal structure of the combiners is explained below.

As described above, since a wireless network has multiple paths, signals must be received through each of the separated multiple channels. Therefore, a wireless network has to include a plurality of fingers to receive separate signals from multiple paths. Each finger processes the different multi-path signals but has the same operation. Therefore, a description for one of fingers is representative of the others in the FIG. 8. First, multi-path signals, the I- and Q-channel signal, received by one of the fingers is input to the descrambler 811. The descrambler 811 performs descrambling for each input signal (the I-channel signal or the Q-channel signal) with each scrambling code applied for the I- or Q-channel signal in transmission apparatus and outputs to a first despreader 813 to a n L^{th} despreader 833. The first despreader 813 receives the I- or Q-channel signal, despreads the received signal with the channelization code employed by the transmission apparatus and then outputs the despread signal to a first and a second antenna channel compensator 817.

Hereinafter, the structure of the scrambler is described with reference to FIGS. 9 and 10.

The descrambler 811 multiplies the I- and Q-channel signal by the scrambling code c employed (applied) by the transmission apparatus. The structure generating the scrambling code c is not depicted in FIG. 8, but is actually the same as that shown in FIG. 9.

FIG. 9 is a block diagram illustrating an example of an internal structure of a receiver scrambling code generator.

Before the reference of FIG. 9, a complex downlink long scrambling code, as described in FIG. 4., is generated using a code sequence that is produced by the operation of the position-wise modulo-3 sum for a 38400 chip of two binary m-sequence. An imaginary part of the binary m-sequence, used to generate the complex downlink long scrambling code, is produced by the 131,072 chip cyclic shifted version of a real part of the binary m-sequence. The procedure generating the complex downlink long scrambling code using two binary m-sequence, an x-sequence and ay-sequence, is explained below.

First, the x-sequence and the y-sequence are produced by the 18^{th} order generating polynomial.

x-sequence: x¹⁸x⁷+1 (1)

y-sequence: x¹⁸+x¹⁷+x⁷+x⁵+1 (2)

As described above, the structure generating the complex downlink long scrambling code with the two binary m-sequences, the x-sequence and the y-sequence, is shown in FIG. 9.

With reference to FIG. 9, a general transmission apparatus involves two mask registers, which are used for the I- and Q-channel of the x-sequence, in order to support an environment using a plurality of physical channels employing different scrambling codes. Two scrambling codes are generated from the two mask registers, respectively. Consequently, scrambling codes for the I- and Q-channel is generated by two mask registers, respectively. The scrambling code generator shown in FIG. 9, has the structure that is able to generate a scrambling code to be used for each finger in order to employ multi-path signals. It is assumed that two scrambling codes are generated in FIG. 9.

The procedure generating a first scrambling code is described below. The reception apparatus scrambling code generator receives the mask values, Fn_PN_{—}1MASK1 and Fn_PN_Q_MASK1 applied for the I- and Q-channel signal, respectively, and masks the x-sequence and the y-sequence, which are from the 18^{th} order generating polynomial, with the mask values, Fn_PN_{—}1MASK1 and Fn_PN_Q_MASK1. As a result of masking, Fn_PN_I1 and Fn_PN_Q1, scrambling codes for the I- and Q-channel, respectively, are generated, respectively. Secondly, the procedure for generating a second scrambling code that is different from a first scrambling code, is described below. The procedure generating a second scrambling code is like that of the first scrambling code. The reception apparatus scrambling code generator receives the mask values, Fn_PN_{—}1MASK2 and Fn_PN_Q_MASK2 applied for the I- and Q-channel signal, respectively, and masks the x-sequence and the y-sequence, which are from the 18^{th} order generating polynomial with the mask values, Fn_PN_{—}1MASK2 and Fn_PN_Q_MASK2. As results of masking, Fn_PN_I2 and Fn_PN_Q2, scrambling codes for the I- and for Q-channel are generated, respectively.

Hereinafter, a internal structure of descrambler will be described with reference to FIG 10.

FIG. 10 is a diagram illustrating the internal structure of descrambler shown in FIG. 8.

With reference to FIG. 10, as described in the FIG. 9, the descrambler 811 receives Fn_PN_I1 and Fn_PN_Q1 to be applied for the I- and Q-channel signal respectively, which are scrambling codes generated from the scrambling code generator. The descrambler 811 descrambles an input signal_I and a input signal_Q by Fn_PN_I1 and Fn_PN_Q1 and outputs the descrambled signals, where the input signal and the input signal_Q are signals input to I channeland Q channel of the finger 711, respectively. The descrambled input signal_I and input signal_Q are called output signal_I and output signal_Q, respectively.

Accordingly, the procedure of generating the output signal_I and the output signal_Q will be explained below in detail.

First, the descrambler 811 includes a plurality of number XOR (eXclusive OR) gates 1011, 1013, 1015, 1017 and 1019 and a plurality of adders 1021 and 1023. The input signal_I input to the finger 711 and the input signal_Q are input to the XOR gates 101 land 1019, and the XOR gates 1013 and 1017, respectively. The XOR gate 1011 operates the input signal_{—}1 xor Fn_PN_I1, a scrambling code generated by the scrambling code generator, and outputs to the adder 1021. The XOR gate 1013 operates the input signal_Q xor Fn_PN_I1, a scrambling code generated by the scrambling code generator and then outputs to the adder 1023. The XOR gate 1019 operates the input signal_I xor a signal from the XOR gate 1015 and outputs to the adder 1023. Herein, a signal output from the XOR gate 1015 is to be operated on by the scrambling code, Fn_PN_Q1, xor −1. The XOR gate 1017 operates the input signal_Q xor a signal from the XOR gate 1015 and outputs to the adder 1021. The adder 1021 adds a signal output from the XOR gate 1011 to a signal output from the XOR gate 1017 and outputs output signal_I. Also, the adder 1023 adds a signal output from the XOR gate 1013 to a signal output from the XOR gate 1019 and outputs output signal_Q.

Each channel is scrambled with reference to a Primary Common Pilot Channel (P-CPICH) when it is transmitted from the transmitter side. Therefore, the descrambler 811 has to synchronize from the timing of P-CPICH. Herein, the timing of P-CPICH is a frame boundary timing of P-CPICH. The I- and the Q-channel signal from the descrambler 811 are output to the first despreader 813 to the L^{th} spreader 833. The first despreader 813 receives the I- and the Q-channel signal from the descrambler 811, multiplies the signals (I-channel and the Q-channel signal) by respective channelization code, which is applied to the first channel of the L channels, to descramble and outputs to the first antenna channel compensator 815 and the second antenna channel compensator 817. The above method is applied to not only the first despreader 813 but also the others. The L^{th} despreader 833 receives the I- and the Q-channel signal from the descrambler 811, multiplies the signals (I-channel and the Q-channel signal) by a respective channelization code, which is applied to the first channel of the L channels, to descramble and outputs to the first antenna channel- compensator 835 and the second antenna channel compensator 837. Herein, the finger unit 711 has to precede a signal on a first channel to an L^{th} channel. Therefore, the first despreader 813 to the L^{th} despreader 833 despread signals on the first channel to the L^{th} channel.

The first antenna channel compensator 815 and the second antenna channel compensator 817 channel-compensate signals from the first despreader 813 and then output the channel-compensated signals to the combining unit 720. In this method, The first antenna channel compensator 835 and the second antenna channel compenstor 837 channel-compensate signals from the L^{th} despreader 833 and then output the channel-compensated signals to the combining unit 720. As described above, the channel-compensated singals are combined in the combining unit 720. The description for an operation of the combining unit 720 follows in detail.

The combining unit 720 includes a plurality of deskewers 841, 851, 861, 871, 881 and 891, a plurality of a first antenna symbol combiners 843, 863 and 883, a plurality of a second symbol combiners 853, 873 and 893. The combining unit 721 conducts combining operation for not only the first finger but also all of fingers involved the finger unit 710. As an example, the operation for signals output from the first finger 711 is described below.

A first channel deskewer 841 receives symbols output from the first antenna channel compensator 815, sorts the symbols according to time in consideration of multi-path latency and then outputs to an antenna 1 channel 1 symbol combiner 843. The antenna 1 channel 1 symbol combiner 843 combines symbols output from the first channel deskewer 841 and outputs the combined symbols. And the first channel deskewer 851 receives symbols output from the second antenna channel compensator 817, sorts the symbols according to time in consideration of multi-path latency and then outputs to an antenna 2 channel 1 symbol combiner 853. The antenna 2 channel 1 symbol combiner 853 combines symbols output from the first channel deskewer 851 and outputs the combined symbols. Accordingly, the antenna 1 channel 1 symbol combiner 843 combines symbols for the first channel received by the first antenna, and the antenna 2 channel 1 symbol combiner 853 combines symbols for the first channel received by the second antenna.

A second channel deskewer 861 receives symbols output from the first antenna channel compensator 825, sorts the symbols according to time in consideration of multi-path latency, and then outputs to an antenna 1 channel 2 symbol combiner 863. The antenna 1 channel 2 symbol combiner 863 combines symbols output from the first channel deskewer 861 and outputs the combined symbols. The second channel deskewer 871 receives symbols output from the second antenna channel compensator 827, sorts the symbols according to time in consideration of multi-path latency, and then outputs to an antenna 2 channel 2 symbol combiner 873. The antenna 2 channel 2 symbol combiner 873 combines symbols output from the second channel deskewer 871 and outputs the combined symbols. Accordingly, the antenna 1 channel 2 symbol combiner 863 combines symbols for the second channel received by the first antenna, and the antenna 2 channel 2 symbol combiner 873 combines symbols for the second channel received by the second antenna. By the above method, symbols for an L^{th} channel, the last channel, are combined in the combining unit 720. An L^{th} channel deskewer 881 receives symbols output from the first antenna channel compensator 835, sorts the symbols according to time in consideration of multi-path latency and then outputs to an antenna 1 channel L symbol combiner 883. The antenna 1 channel L symbol combiner 883 combines symbols output from the first channel deskewer 881 and outputs the combined symbols. And the second channel deskewer 891 receives symbols output from the second antenna channel compensator 837, sorts the symbols according to time in consideration of multi-path latency and then outputs to an antenna 2 channel L symbol combiner 893. The antenna 2 channel L symbol combiner 893 combines symbols output from the second channel deskewer 891 and outputs the combined symbols. Accordingly, the antenna I channel L symbol combiner 883 combines symbols for the L channel received by the first antenna, and the antenna 2 channel L symbol combiner 893 combines symbols for the L channel received by the second antenna. The above deskewers should be designed in consideration of time latencies from a first path to a second path.

For reference, symbols for a k^{th} channel of a signal received by an N^{th} multi-path are summarized by the below Equation 1.

$${S}_{K} ( n ) = {\sum }_{i = 1}^{finger} {\{ \sum }_{i = 1}^{SF} {R}_{ij} \cdot {c}_{j} \cdot {α}_{i}^{*} \cdot {w}_{jk} \} \qquad Equation 1$$

In Equation 1, i, j, Rij, ^{α}^{^{*}}^{ᵢ}, w and c represent a finger index, a Walsh code index, a j^{th} chip signal of an nth symbol received by a i^{th} finger, a conjugate from a pilot filter of an I^{th} finger, a Walsh code, and a scrambling code.

As described above, FIG. 8 shows that each finger despreads by using a plurality of Walsh codes, and channelization codes.

Traditional mobile communication systems based on a voice services have used the method of transmitting by assigning one or several Walsh codes to an data channel. In this case, a traditional rake receiver comprising a plurality of fingers despreads respective Walsh code, channelization code, assigned to each finger, channel-compensates the despread channel and combines the channel-compensated symbols in multi-path symbol combiners. As CDMA-based mobile communication systems, which support the transmission of high speed packet data, variably assign all of Walsh codes to users in order to efficiently manage resources, data are able to be transmitted in high speed. That is, high speed channel can use all of Walsh codes that the mobile communication systems are capable of assign.

Thus, when a rake receiver, which is using a traditional multi-path symbol combiner, modulates signals received through data channel using multiple Walsh codes, the rake receiver must modulate each of its fingers with the multiple Walsh codes, respectively. For this reason, the rake receiver has disadvantages that its fingers have large overhead so that its hardware complexity increase. In order to remove that disadvantages, a method using the receiver structure, which performs a combining of and a channel-compensation of multi-path signals at a chip level, is lately considered

Hereinafter, a internal structure of a finger unit and a combining unit in a case that a combining unit performs despreading.

FIG. 11 is a diagram illustrating an example of the internal structure of a finger unit and a combining unit in a case that a combining unit performs despreading.

With reference to FIG. 11, the finger unit 1100 includes M fingers, a first finger 1110 to an M^{th} finger 1150, as in the finger unit 710 of FIG. 8. The combining unit 1180 includes two deskewers 1121 and 1161, as well as two combiners 1123 and 1163.

First, the internal structure of the finger unit 1110 is described below.

As described above, since a wireless network has multiple paths, the network has to divide multiple paths into each path, and then receive signal on each path. Therefore, a wireless network has to include a plurality of fingers to receive separately signals from multiple paths. Each of the fingers has the same operation but processes different multi-path signals. As several example, each operation of a first finger 1110 and an M^{th} finger 1150 on FIG. 11 is described below. First, multi-path signals, I-channel signal and Q-channel signal, received by one of fingers is input to the descrambler 1111 of the first finger 1110. The descrambler 1111 performs descrambling of each input signal (the I-channel signal or the Q-channel signal) with each scrambling code applied for the I-channel or for the Q-channel signal in transmission apparatus and outputs to a first antenna channel compensator 1113 and a second antenna channel-compensator 1115. The first antenna channel compensator 1113 receives the despread I-channel and Q-channel signal from the descrambler 1111, channel-compensates each signal and outputs the channel-compensated signals to a deskewer 1121 of the combining unit 1180. The second antenna channel compensator 1115 receives the despread I-channel and the Q-channel signal from the descrambler 1111, channel-compensates each signal and outputs the channel-compensated signals to a deskewer 1161 of the combining unit 1180.

As in the foregoing method, the received multi-path signals, the I- and Q-channel signal, are input to a descrambler 1151 of the M^{th} finger, the last finger of the finger unit 1110. The descrambler 1151 performs descrambling of each input signal (the I-channel signal or the Q-channel signal) with each scrambling code applied for the I-channel or for the Q-channel signal in transmission apparatus and outputs to a first antenna channel compensator 1153 and a second antenna channel compensator 1155. The a first antenna channel-compensator 1153 receives each signal of the descrambled I-channel signal and Q-channel signal, performs channel compensating for the received signals and then outputs the channel-compensated to the deskewer 1121. The second antenna channel compensator 1155 receives each signal of the descrambled I-channel signal and Q-channel signal, performs channel compensating for the received signals and then outputs the channel-compensated signals to the deskewer 1161.

The deskewer 1121 receives chips output from the first antenna channel compensators 1113 to 1153, to be included the first finger 1100 through the M^{th} finger 1150, respectively, sorts the chips according to time in consideration of multi-path latency and then outputs the chips to an antenna 1 chip combiner 1123. The antenna 1 chip combiner 1123 receives the I-channel and the Q-channel signal from output the deskewer 1121, combines the received signals at a chip level and outputs the chip level signals. Also the deskewer 1161 receives chips output from the second antenna channel-compensators 1115 through 1155, to be included the first finger 1100 through the M^{th} finger 1150, respectively, sorts the chips according to time in consideration of multi-path latency and then outputs the chips to an antenna 2 chip combiner 1163. The antenna 2 chip combiner 1163 receives the I-channel and the Q-channel signal from output the deskewer 1161, combines the received signals at a chip level and outputs the chip level signals.

Thus, the 1 antenna chip combiner 1123 combines multi-path signals received by a first antenna at a chip level and outputs I-channel signal and Q-channel signal to the corresponding channel. Then, the I- and Q-channel signal are despread by a plurality of channelization codes (e.g., L codes) in order to diminish the hardware complexity of each finger. In the same manner, the 2 antenna chip combiner 1163 combines multi-path signals received by a second antenna at a chip level and outputs I-channel signal and Q-channel signal to the corresponding channel. Then, the I- and Q-channel signal are despread by a plurality of channelization codes (e.g., L ones) in order to diminish the hardware complexity of each finger.

For reference, symbols for a k^{th} channel of a signal received by a Nth multi-path are represented by Equation 2 given below.

$${S}_{K} ( n ) = {\sum }_{j = 1}^{SF} \{ \{ {\sum }_{n = 1}^{finger} {R}_{ij} \cdot {c}_{j} \cdot {α}_{i}^{*} \} \cdot {w}_{jk} \} \qquad [ Equation 2 ]$$

In Equation 2, i, j, Rij, ^{α}^{^{*}}^{ᵢ}, w and c represent a finger index, a Walsh code index, a j^{th} chip signal of an N^{th} symbol received by a i^{th} finger, a conjugate from a pilot filter of an i^{th} finger, a Walsh code, and a scrambling code, respectively.

Equation 2 represents received symbols received, when channel-despreading occurs in the combining unit and Equation 1 represents received symbols, when channel-despreading occurs in the finger unit. Comparing Equation 1 with Equation 2, it can be seen that the two equations are substantially equal to each other except that their elements are arranged in different sequences. Consequently, whether the location channel-despreading is a combining unit or a finger unit, the result of channel-despreading is the same.

However, a reception apparatus, performs channel compensating at a chip level and combining multi-path signals, consumes a good deal of power when it demodulates high speed channel signals. The power consumption of the reception apparatus has a critical influence on the total power of the mobile station. The excessive dissipation of mobile station power causes many problems. Therefore, a mobile station reception method capable of minimizing unnecessary dissipation of power and also complexity of hardware and overhead of fingers is required.

### SUMMARY OF THE INVENTION

Accordingly, the present invention has been made to solve the above-mentioned problems occurring in the prior art, and an object of the present invention is to provide a reception apparatus and method, which can minimize the complexity of a hardware in code division multiple access mobile communication system.

It is a second object of the present invention to provide a reception apparatus and method, which can minimize power consumption

It is a third object of the present invention to provide a reception apparatus and method, which can employ post-descrambling in code division multiple access mobile communication system.

In order to substantially accomplish these objects, according to an embodiment of the present invention, there is provided a reception apparatus in a code division multiple access mobile communication system, in which L channel signals are transmitted by N transmission antennas of a transmission apparatus and received through M multi-paths by the reception apparatus, the reception apparatus comprises a finger unit which receives and channel-compensates multi-path signals received through the M multi-paths; and a combining unit which receives the multi-path signals output from the finger unit, sorts the multi-path signals according to time in consideration of multi-path latency, combines the sorted signals, and descrambles each of the combined signals by means of one of preset scrambling codes.

In order to substantially accomplish these objects, according to an embodiment of the present invention, there is provided a reception apparatus in a code division multiple access mobile communication system, in which L channel signals are transmitted by N transmission antennas of a transmission apparatus and received through M multi-paths by the reception apparatus, the reception apparatus comprises a deskewer which receives and sorts each of the multi-path signals through the M multi-paths according to time in consideration of multi-path latency; a finger unit which receives the sorted signals output from the deskewer and channel-compensates the sorted signals; and a combining unit which receives and combines the channel-compensated signals and descrambles each of combined signals by means of one of preset scrambling codes.

In order to substantially accomplish these objects, there is provided a reception method employed in a code division multiple access mobile communication system, in which L channel signals are transmitted by N transmission antennas of a transmission apparatus and received through M multi-paths by a reception apparatus, the reception method comprises the steps of (1) receiving and channel-compensating the multi-path signals through the multi-paths; and (2) receiving the channel-compensated signals, sorting the channel-compensated signals according to time in consideration of the multi-path latency, combining the sorted signals with each other, and descrambling each of the combined signals by using one of the preset scrambling codes.

In order to substantially accomplish these objects, there is provided a reception method employed in a code division multiple access mobile communication system, in which L channel signals are transmitted by N transmission antennas of a transmission apparatus and received through M multi-paths by a reception apparatus, the reception method comprises the steps of (1) inputting each of the received multi-path signals through the M multi-paths, sorting the multi-path signals according to time in consideration of the multi-path latency; (2) inputting and channel-compensating the sorted signals; and (3) combining the channel-compensated signals and descrambling each of the combined signals by using one of preset scrambling codes.

### BRIEF DESCRIPTION OF THE DRAWINGS

FIG. 1 is a diagram illustrating an example of a structure of a transmission apparatus of a general_High Speed Downlink Packet Access (HSDPA) mobile communication system;

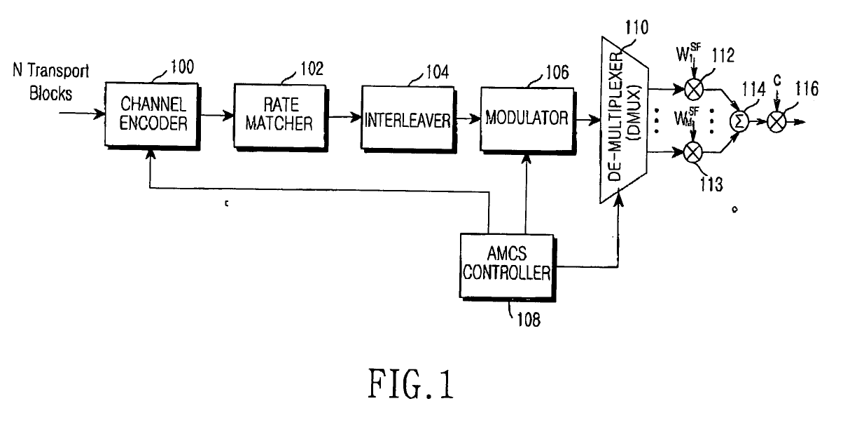

FIG. 2 is a diagram illustrating an example of allocating Orthogonal Variable Spreading Factor (OVSF) codes in a general HSDPA mobil communication system;

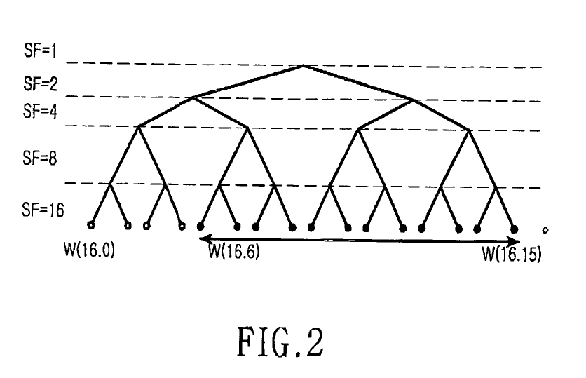

FIG. 3 is a diagram illustrating an example of a structure of a general OVSF code tree;

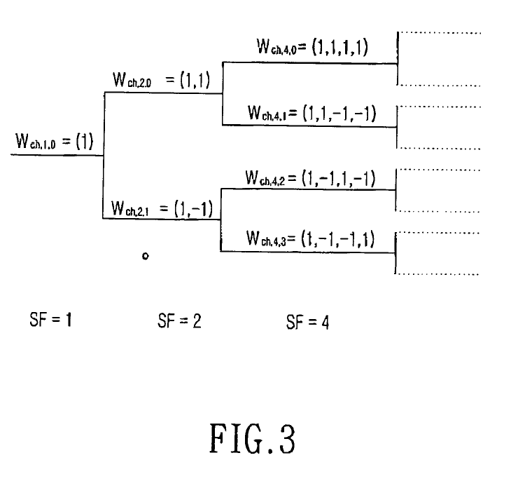

FIG. 4 is a diagram illustrating an example of an internal structure of a transmitter scrambling code generator;

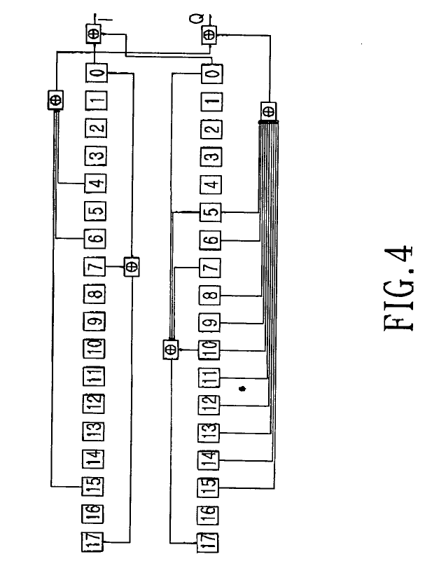

FIG. 5 is a diagram illustrating an example of an internal structure of a scrambler shown in FIG. 1;

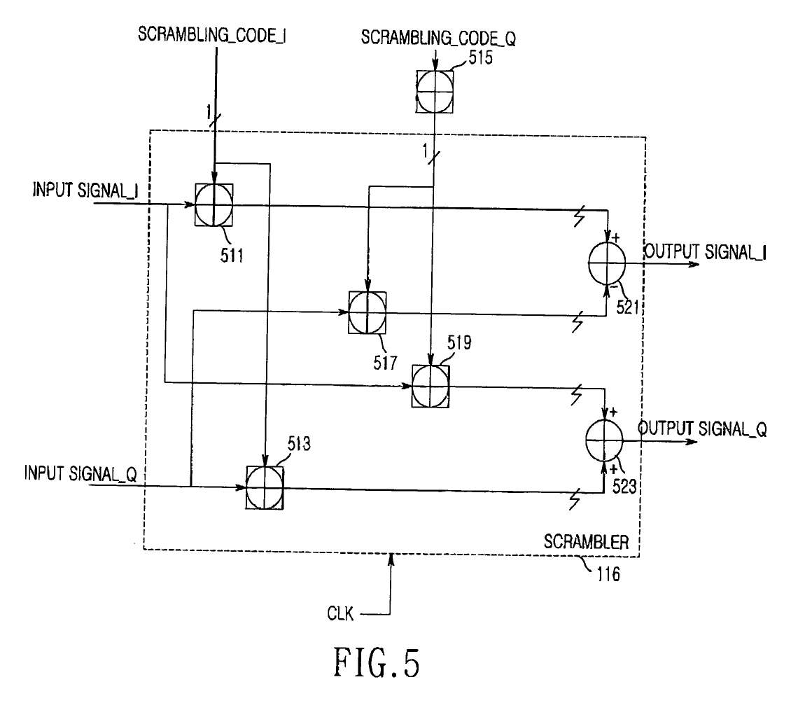

FIG. 6 is a diagram illustrating an example of a channelization procedure using OVSF code;

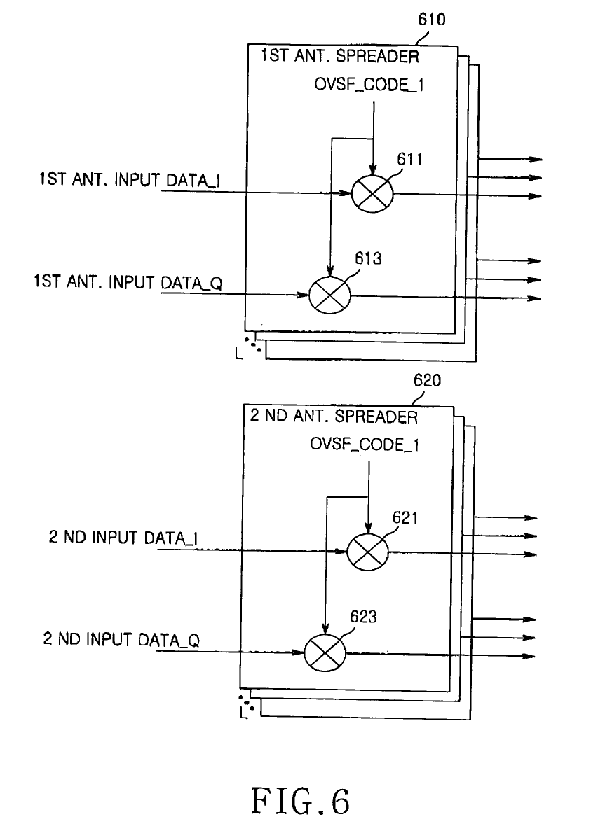

FIG. 7 is a block diagram illustrating an example of a reception apparatus structure of a general HSDPA mobile communication system;

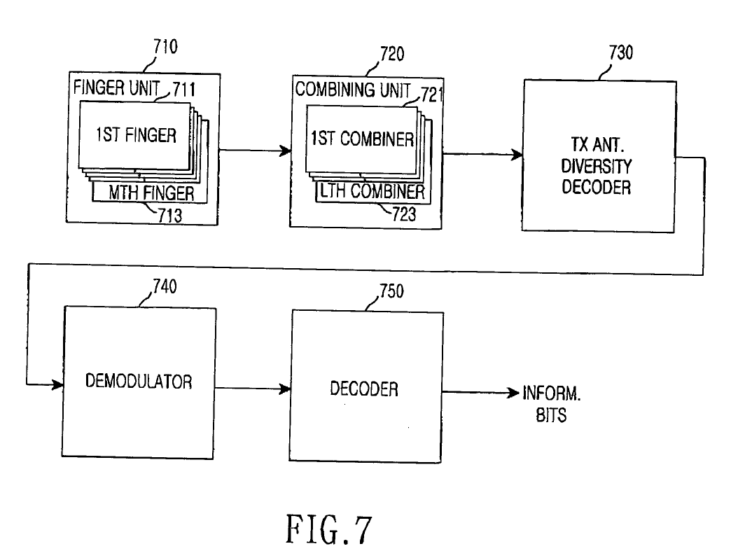

FIG. 8 is a diagram illustrating an example of an internal structure of a finger unit and of the combiner unit shown in FIG. 7;

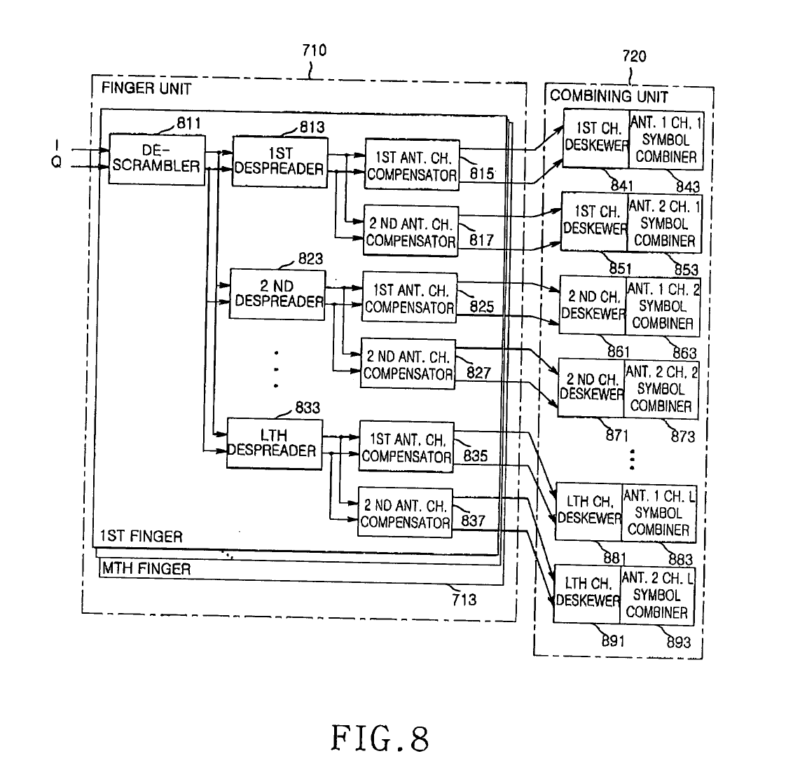

FIG. 9 is a diagram illustrating an example of an internal structure of a reception apparatus scrambling code generator;

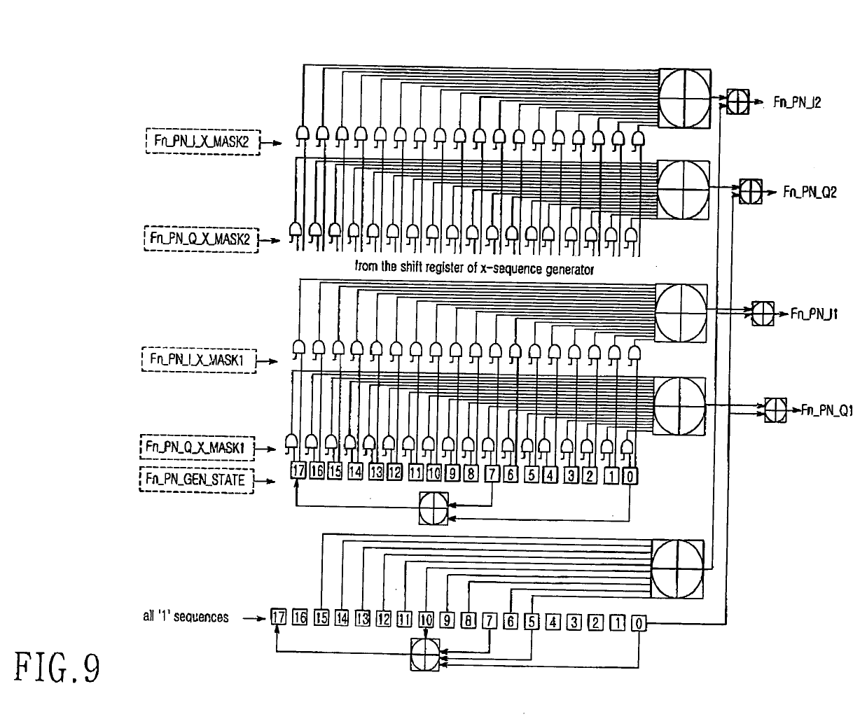

FIG. 10 is a diagram illustrating an example of the an internal structure of the descrambler shown in FIG. 8;

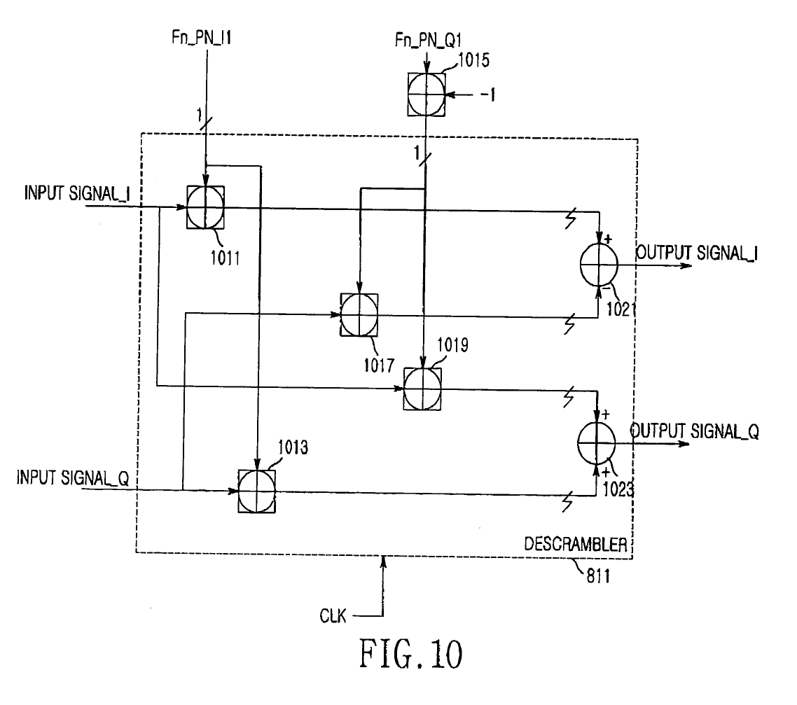

FIG. 11 is a diagram illustrating an example of an internal structure of a finger unit and a combining unit if a combining unit performs despreading;

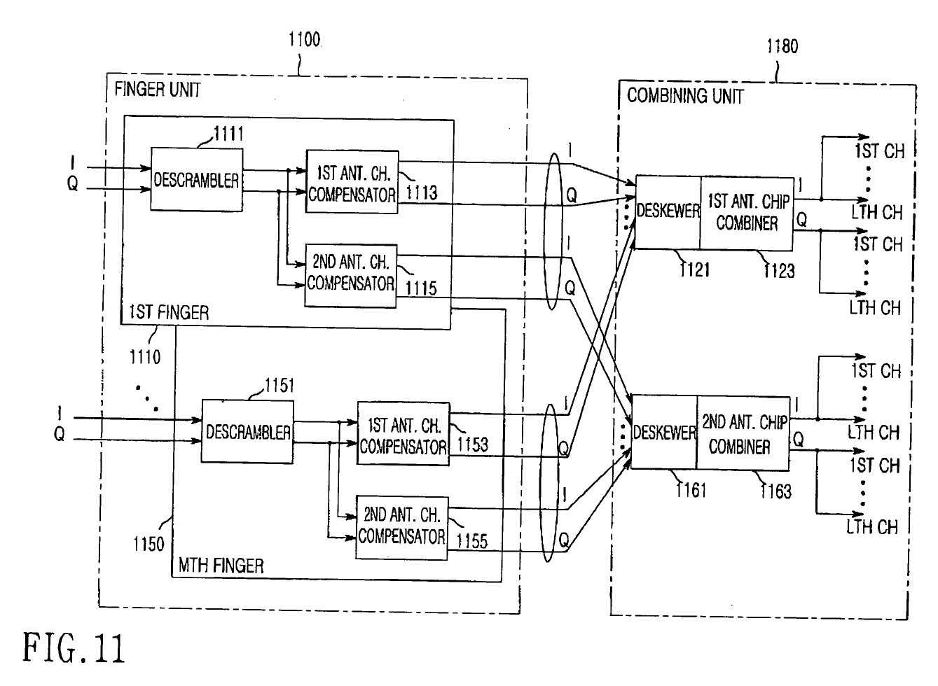

FIG. 12 is a diagram illustrating an example of an internal structure of a reception apparatus using a post-descrambler according to a first embodiment of the present invention; and a

FIG. 13 is a diagram illustrating an example of an internal structure of a reception apparatus using a post-descrambler according to a second embodiment of the present invention.

### DETAILED DESCRIPTION OF THE PREFERRED EMBODIMENTS

Hereinafter, preferred embodiments of the present invention will be described in detail with reference to the accompanying drawings. Note that the same or similar components in drawings are designated by the same reference numerals. In the following description of the present invention, a detailed description of known functions and configurations incorporated herein will be omitted for conciseness.

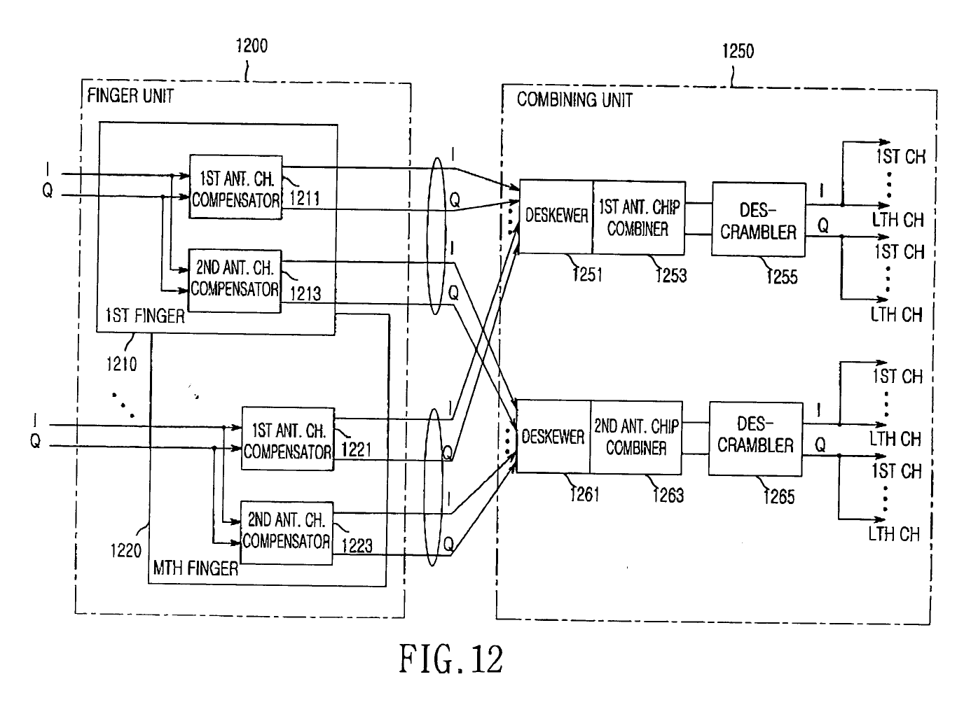

FIG. 12 is a diagram illustrating an example of an internal structure of a reception apparatus using a post-descrambler according to a first embodiment of the present invention.

Generally, a reception apparatus includes finger unit combining unit, a Tx antenna diversity decoder, a demodulator, and a decoder. For the brief description, however only the finger unit and the combining unit are described in FIG. 12. The detailed description of the Tx antenna diversity decoder, the demodulator, and the decoder are omitted in this paragraph.

With reference to FIG. 12, the finger unit includes 1200 a plurality of fingers, a first finger 1210 through an M^{th} finger 1220. The combining unit 1250 includes, as one example, two deskewers 1251 and 1261, a first antenna chip combiner 1253, a second antenna chip combiner 1263 and two descramblers. The combining unit 1250 performs despeading for I-channel signal and Q-channel signal output from each descrambler 1255, 1265 by using a plurality of channelization codes (as an example, L channelization codes), although FIG. 12 does not directly show the procedure of despreading

First, signals are received by an antenna. The received signals are multi-path signals, which have been subjected to fading. Signals on the multi-path are connected to the targeted fingers, respectively. Thus, the reception apparatus has to comprise many number of fingers in order to take gains of signals according to multi-path. FIG. 12 shows the finger unit comprising M fingers. Also, transmission apparatus corresponding to the reception apparatus can transmit signals by a plurality of antennas. FIG. 12 shows that the transmission apparatus transmit signals by two antennas and the reception apparatus receives signals with the two antennas, a first antenna, a second antenna, according to an embodiment of the present invention.

First, the internal structure of the finger unit 1200 is described below.

As described above, since a wireless network has multiple paths, signals must be received through each of the separate multiple channels. Therefore, a wireless network has to include a plurality of fingers to receive separate signals from multiple paths. Each of the many fingers has the same operation but processes different multi-path signals. Therefore, operations of the first finger 1210 and the M^{th} finger 1220 are described as an example in FIG. 12. First, the received multi-path signals, the I- and the Q-channel signal, are input to an antenna 1 channel compensator and an antenna 2 channel compensator 1213. The antenna 1 channel compensator 1211 performs channel compensating the input the I- and the Q-channel signal and outputs the signals to a deskewer 1251 of the combing unit. The antenna 2 channel compensator 1213 performs channel compensating for the input the I- and the Q-channel signal and outputs the signals to a deskewer 1261 of the combing unit.

Similarly, the received multipath-signals, the I- and the Q-channel signal are input to an antenna 1 channel compensator 1211 and an antenna 2 channel compensator 1213, which are comprised of the M^{th} finger 1220 in the finger unit 1200. The antenna 1 channel compensator 1221 channel-compensates the input the I- and Q-channel signal and outputs the channel-compensated signals to a deskewer 1251 of the combing unit. The antenna 2 channel compensator 1223 channel-compensates for the input the I- and Q-channel signal and outputs the channel-compensated signals to a deskewer 1261 of the combing unit.

The deskewer 1251 receives chips output from the antenna 1 channel compensators 1211 and 1221 of the first finger 1210 to the M^{th} finger unit 1220, sorts the chips according to time in consideration of multi-path latency and then outputs the sorted chips to an antenna 1 chip combiner 1253. The antenna 1 chip combiner 1253 receives the I- and Q-channel signals from the deskewer 1251, combines the signals at a chip level and outputs individually the combined the I- and Q-channel signals to a descrambler 1255. Also, The deskewer 1261 receives chips output from the antenna 1 channel compensators 1213 and 1223 of the first finger 1210 through the M^{th} finger unit 1220, sorts the chips according to time in consideration of multi-path latency and then outputs to an antenna 2 chip combiner 1263. The antenna 2 chip combiner 1263 receives the I- and the Q-channel signals from the deskewer 1261, combines signals at a chip level and outputs individually the I- and Q-channel signals combined at a chip level to a descrambler 1265. Thus, the I- and Q-channel signals, which are output from the antenna 1 chip combiner 1253, are individually output to descrambler 1255. Herein, the I- and Q-channel signals are combined at a chip level.

Thus, The descrambler 1255 receives individually the I- and Q-channel signals, which are combined at a chip level from the antenna 1 chip combiner 1253, performs descrambling with the scrambling code applied for the transmission apparatus and outputs. Thus, the I- and Q-channel signals, which are output from the antenna 2 chip combiner 1263, are individually output to descrambler 1265. Herein, the I- and Q-channel signals are combined at a chip level. The descrambler 1265 receives individually the I- and Q-channel signals, which are combined at a chip level from the antenna 2 chip combiner 1263, performs descrambling with the scrambling code applied for the transmission apparatus.

The descrambled I- and Q-channel signal from the descrambler 1255, individually despread by a plurality channelization codes (as an example, L channelization codes). This method reduces the hardware complexity of the fingers. As the descrambled I- and Q-channel signal are despread by L channelization codes, L channel signals are demodulated on a first channel to L^{th} channel. Thus, the I- and Q-channel signal from the descrambler 1265, individually despread by a plurality 20 channelization codes (as an example, L channelization codes). This method reduces the hardware complexity of the fingers. As the descrambled I- and Q-channel signal are despread by L channelization codes, L channel signals are demodulated on a first channel to an L^{th} channel.

For reference, symbols for a k^{th} channel of a signal received by an N^{th} multi-path are summarized by the below Equation 3.

$${S}_{K} ( n ) = {\sum }_{j = 1}^{SF} \{ \{ {\sum }_{n = 1}^{finger} {R}_{ij} \cdot {c}_{j} \cdot {α}_{i}^{*} \} \cdot {w}_{jk} \} \qquad [ Equation 3 ]$$

In Equation 3, i, j, Rij, ^{α}^{^{*}}^{ᵢ}, w and c represent a finger index, a Walsh code index, a j^{th} chip signal of a N^{th} symbol received by a i^{th} finger, an conjugate from a pilot filter of a i^{th} finger, a Walsh code, and a scrambling code.

Equation 3 represents received symbols when channel-despreading and descrambling are performed at a combining unit in a reception apparatus using a post-descrambler, the combining unit 1250, and the traditional Equation 1 represents received symbols in a case of channel-despreading and descrambling in the finger unit. Equation 2 represents received symbols in a case of descrambling in finger unit and channel-despreading in combining unit. Comparison of Equation 1, Equation 2 and Equation 3 shows that the three equations are substantially equal to one another except that their elements are arranged in different sequences. The results of three cases, e.g., the case of descrambling and channel-despreading in finger unit, the case of descrambling in finger unit and channel-despreading operation in combining unit, and the case of channel-despreading and descrambling in combining unit, are the same.

Advantages of a reception apparatus using a post-descrambler, shown in FIG. 12, are explained in the next.

First, as described above about the conventional apparatus, in a case of that the received signals on data channel using multiple Walsh codes is demodulated, the rake reception apparatus, using a traditional multi-path symbol combiner, has many problems, that is large overhead of the fingers, increase hardware complexity, etc. The above problems are eliminated by employing channel compensation of chip level and combination of multi-path signals in the reception apparatus.

But, this reception apparatus, employing channel compensation of chip level and combination of multi-path signals consumes large amounts of power when it demodulates high speed channel signals. The overload of the reception apparatus and a great deal of consumption of its power affect the mobile station, and so cause a critical problem. But the reception apparatus using a post-scrambler, as described in FIG. 12, is able to demodulate high speed data channel signals while minimizing the consumption of its power, the complexity of its hardware, and the overhead of its fingers.

Next description is about the internal structure of the reception apparatus using a post-scrambler according to a second embodiment of the present invention.

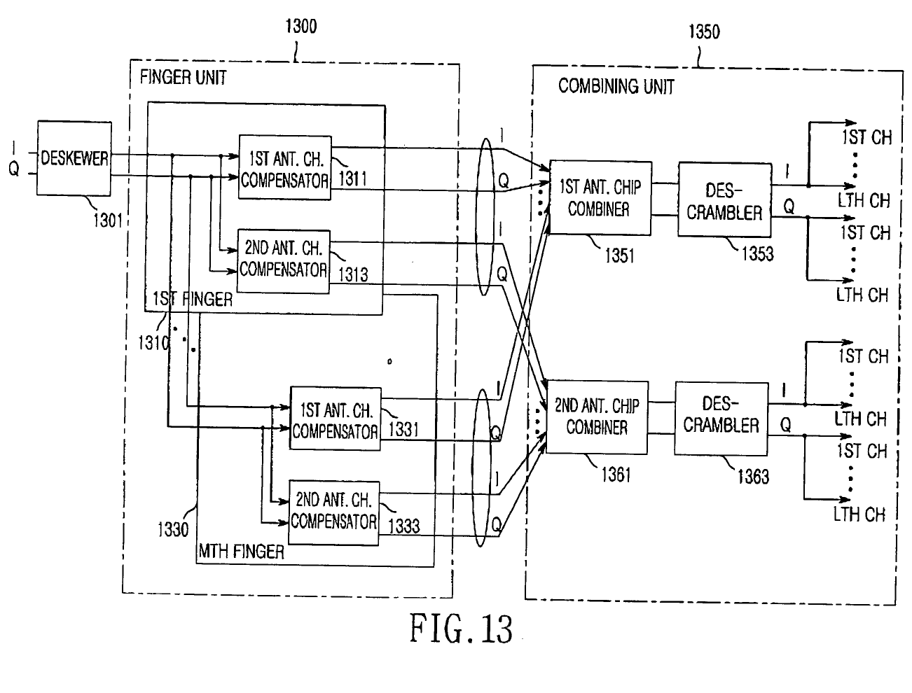

FIG. 13 is a diagram illustrating an example of an internal structure of a reception apparatus using a post-descrambler according to a second embodiment of the present invention.

Before the description of FIG. 13, the present invention, as described in FIG. 12, generally includes a finger unit, a combining unit, a Tx antenna diversity decoder, a demodulator and a decoder. However, for the brief description, only the finger unit 1300 and the combining unit 1350 are described in FIG. 13. The description of the Tx antenna diversity decoder, the demodulator, and the decoder are omitted in this paragraph. As can seen from FIG. 13, the reception apparatus is provided with a deskewer 1301, which is not limited to the number according to conditions of the reception apparatus, such as the number of Rx antennas and so forth. The finger unit 1300 includes a plurality of fingers (e.g. M ones, i.e., a first finger 1310 to an M^{th} finger 1330). The combining unit 1350 includes a first antenna chip combiner 1351, a second antenna chip combiner 1361 and two descramblers 1353 and 1363. Also, even though not directly shown in FIG. 13, the combining unit 1350 performs a despreading operation for the I-channel signal and Q-channel signal with a plurality of channelization codes (e.g. L codes). First, signals are received by an antenna. The received signals are multi-path signals, which have been subjected to fading. Each of the signals on the multi-path are connected to the respective targeted fingers. Thus, the reception apparatus has to comprise many fingers in order to determine gains of signals according to multi-path. Therefore, FIG. 13 shows the finger unit comprising the M fingers. Also, a transmission apparatus corresponding to the reception apparatus can transmit signals with a plurality of antennas. FIG. 13 shows the case that the transmission apparatus transmits signals by two antennas and so the reception apparatus receives signals by the two antennas, a first antenna, a second antenna, as an embodiment according to the present invention.

First, if multi-path signals, the I- and Q-channel signal, are received at the reception apparatus, the received signals are individually input to the deskewers 1301. The deskewer 1301 receives the received I-channel signal and Q-channel signal, sorts the signals according to time in consideration of multi-path latency and output the sorted signals to a first and a second antenna channel- compensator, 1311 and 1313, of the first finger 1310. The first antenna channel compensator 1311 receives individually the I- and Q-channel signal, channel-compensates the received signals and outputs the channel-compensated signals to the first antenna chip combiner 1351 of the combining unit 1350. Also, the second antenna channel compensator 1313 receives individually the I-channel and Q-channel signal, channel-compensates the received signals and outputs the channel-compensated signals to the first antenna chip combiner 1361 of the combining unit 1350.

Similarly, the multi-path signals (the I-channel signal and Q-channel signal) are input to the first antenna channel compensator 1331 and the second antenna channel compensator 1333, which are an M^{th} finger 1330 (the last finger) in the finger unit 1300. The first antenna channel compensator 1331 receives individually the I- and Q-channel signal, channel-compensates for the received signals and outputs the channel-compensated signals to the first antenna chip combiner 1351. Also, the second antenna channel compensator 1333 receives individually the I- and Q-channel signal, channel-compensates for the received signals and outputs the channel-compensated signals to the first antenna chip combiner 1361.

The first antenna chip combiner 1351 receives the I-channel signal and Q-channel signal, output from each of the first antenna compensators 1311 and 1331 in the first finger 1310 through the M^{th} finger 1330, combines the signals at a chip level and outputs the combined signals to the descrambler 1353. The descrambler 1353 receives individually the I- and Q-channel signal, descrambles individually the I- and Q-channel signal with respective scrambling code employed for the I- or Q-channel signal by a transmission apparatus. Thus, the second antenna chip combiner 1361 receives the I- and Q-channel signal output from each of the second antenna chip compensators 1313 and 1333 in the first finger 1310 to the M^{th} finger 1330, combines the signals at a chip level and outputs the combined signals to the descrambler 1363. The descrambler 1363 receives individually the I- and Q-channel signal, descrambles individually the I- and Q-channel signal with each of scrambling codes employed for the I- or Q-channel signal by transmission apparatus.

The descrambled the I- and Q-channel signals output from the descrambler 1353 are despread by a plurality of channelization codes (e.g., L codes) in order to diminish the hardware complexity of each finger. Thus, L channel signals, a first to an L^{th} channel signal, are demodulated by despeading the descrambled I- and Q-channel signals with L channelization code. Similarly, The descrambled I- and Q-channel signals output from the descrambler 1363 are despread by a plurality of channelization codes (e.g., L codes) in order to diminish the hardware complexity of each finger. Thus, L channel signals, which are a first to an L^{th} channel signal, are demodulated by despeading the descrambled I- and Q-channel signals by using respective L channelization code.

For reference, in the structure of the reception apparatus, symbols for a k^{th} channel of a signal received by an N^{th} multi-path are summarized by the below Equation 4.

$${S}_{K} ( n ) = {\sum }_{j = 1}^{SF} \{ \{ {\sum }_{n = 1}^{finger} {R}_{ij} \cdot {c}_{j} \cdot {α}_{i}^{*} \} \cdot {w}_{jk} \} \qquad [ Equation 4 ]$$

In above Equation 4, i, j, Rij, ^{α}^{^{*}}^{ᵢ}, w and c represent a finger index, a Walsh code index, a j^{th} chip signal of a N^{th} symbol received by a i^{th} finger, a conjugate from a pilot filter of a i^{th} finger, a Walsh code, and a scrambling code.

The Equation 4 represents received symbols in a case of channel-despreading and descrambling at a combining unit in a reception apparatus using a post-descrambler. When a deskewer is located just before a finger unit, Equation 4 represents received symbols when channel-despreading and descrambling occurs in the combining unit. Equation 1 represents received symbols when channel-despreading and descrambling occur in the finger unit. Equation 2 represents received symbols when descrambling occurs in the finger unit and channel-despreading in the combining unit. Comparison of Equation 1, Equation 2, Equation 3 and Equation 4 shows that the four equations are substantially equal to one another except that their elements are arranged in different sequences. The results of four cases, e.g., the case of descrambling and channel-despreading in finger unit, the case of descrambling in finger unit and channel-despreading in combining unit, and the case of channel-despreading and descrambling in combining unit, are the same.

When a deskewer is located just before a finger unit in FIG. 13, advantages can be seen.

If the deskewer is located just before or inside of the combining unit, fingers of the finger unit operate independently by their own timing. As seen in FIG. 13, when the deskewer is located just before a finger unit, timing of signals input to each finger of the finger unit is the same. As a result, all of the fingers in the finger unit are operated by the same timing.

When an multipath interference cancellator (MPIC) comprising several rake reception apparatus is considered, the number of fingers decrease in proportion to that of the rake reception apparatus is comprised in the MPIC.

As described above, the present invention has the advantage of minimizing the overhead of fingers and the hardware complexity, as well as being able to demodulate a high speed data channel signal by minimal consumption of power in a CDMA mobile communication system employing post-descrambling mode.

While the invention has been shown and described with reference to certain embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A reception apparatus in a code division multiple access mobile communication system, in which L channel signals are transmitted by N transmission antennas of a transmission apparatus and received through M multi-paths by the reception apparatus, the reception apparatus comprising:
a finger unit which receives and channel-compensates multi-path signals received through the M multi-paths; and
a combining unit which receives the multi-path signals output from the finger unit, sorts the multi-path signals according to time in consideration of multi-path latency, combines the sorted signals, and descrambles each of the combined signals by means of one of preset scrambling codes.

2. A reception apparatus according to claim 1, wherein the finger unit comprises M fingers which receive the multi-path signals and channel- compensate each of the multi-path signals by means of each of the N antenna channel compensators.

3. A reception apparatus according to claim 2, wherein the combining unit comprises:
N deskewers which receive the channel-compensated signals output from each of the antenna channel compensators of each the fingers and sort the channel-compensated signals according to time in consideration of multi-path latency;
N antenna chip combiners which receive the sorted signals output from each of the N deskewers and combine the sorted signals at a chip level; and
N descramblers which receive a signal the combined signals output from each of N antenna chip combiner and descramble the combined signal by means of a preset scrambling code.

4. A reception apparatus according to claim 3, wherein the combining unit further comprises despreaders which despread descrambled signals output from each of the N descramblers by using respective L channelization codes.

5. A reception apparatus according to claim 1, wherein the sorted signals are combined at a chip level in a combination unit.

6. A reception apparatus in a code division multiple access mobile communication system, in which L channel signals are transmitted by N transmission antennas of a transmission apparatus and received through M multi-paths by the reception apparatus, the reception apparatus comprising:
a deskewer which receives and sorts each of the multi-path signals through the M multi-paths according to time in consideration of multi-path latency;
a finger unit which receives the sorted signals output from the deskewer and channel-compensates the sorted signals; and
a combining unit which receives and combines the channel-compensated signals and descrambles each of combined signals by means of one of preset scrambling codes.

7. A reception apparatus according to claim 6, wherein the finger unit comprises M fingers, each of which includes N antenna channel compensators which receive and channel-compensate the multi-path signals, respectively.

8. A reception apparatus according to claim 7, wherein the combining unit comprises:
N antenna chip combiners which input and combine the channel-compensated signals output from each of N the antenna channel compensators of each of the fingers; and
N descramblers which receive the combined signals output from the antenna chip combiners and descramble each of the combined signals by using one of preset scrambling codes.

9. A reception apparatus according to claim 8, wherein the combining unit further comprises despreaders which despread the descrambled signals output from each of the N descramblers by using respective L channelization codes.

10. A reception apparatus according to claim 6, wherein the number of the deskewers increases in proportion to the number of reception antennas.

11. A reception apparatus according to claim 6, wherein the channel-compensated signals are combined at a chip level.

12. A reception method employed in a code division multiple access mobile communication system, in which L channel signals are transmitted by N transmission antennas of a transmission apparatus and received through M multi-paths by a reception apparatus, the reception method comprising the steps of:
(1) receiving and channel-compensating the multi-path signals through the multi-paths; and
(2) receiving the channel-compensated signals, sorting the channel-compensated signals according to time in consideration of the multi-path latency, combining the sorted signals with each other, and descrambling each of the combined signals by using one of the preset scrambling codes.

13. A reception method according to claim 12, wherein, in step (1), the multi-path signals through the M multi-paths are received and channel-compensated in consideration of each of the N antennas.

14. A reception method according to claim 13, wherein step (2) comprises the steps of:
receiving the channel-compensated signals of each of the M multi-paths in consideration of each of the N antennas, and sorting the channel compensated signals according to time in consideration of the multi-path latency;
combining the sorted signals at a chip level; and
descrambling each of the combined signals at a chip level by means of one of preset scrambling codes.

15. A reception method according to claim 14, wherein step (2) further comprises a step of despreading each of descrambled signals by means of respective L channelization codes.

16. A reception method according to claim 12, wherein, in step (2), the sorted signals are combined at a chip level.

17. A reception method employed in a code division multiple access mobile communication system, in which L channel signals are transmitted by N transmission antennas of a transmission apparatus and received through M multi-paths by a reception apparatus, the reception method comprising the steps of:
(1) inputting each of the received multi-path signals through the M multi-paths, sorting the multi-path signals according to time in consideration of the multi-path latency;
(2) inputting and channel-compensating the sorted signals; and
(3) combining the channel-compensated signals and descrambling each of the combined signals by using one of preset scrambling codes.

18. A reception method according to claim 17, wherein, in step (2), the multi-path signals through the M multi-paths are received and channel-compensated in consideration of each of the N antennas.

19. A reception method according to claim 18, wherein the step (2) comprises the steps of:
combining the channel compensated signals at a chip level; and
descrambling each of the combined signals at a chip level by using one of preset scrambling codes.

20. A reception method according to claim 19, wherein the step (2) further comprises a step of despreading each of the descrambled signals by using respective L channelization codes.

21. A reception method according to claim 17, wherein, in step (3), the channel-compensated signals are combined at a chip level.
